(19) United States
(12) Patent Application Publication
(10) Pub. No.: US 2009/0179735 A1
(43) Pub. Date: Jul. 16, 2009

(54) SECURITY SYSTEMS

(76) Inventor: Pierre C. Van Rysselberghe, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 12/332,282

(22) Filed: Dec. 10, 2008

Related U.S. Application Data
(63) Continuation of application No. 10/258,187, filed on Jun. 30, 2003, now abandoned.
(60) Provisional application No. 60/199,003, filed on Apr. 19, 2000.
(60) Provisional application No. 60/203,079, filed on May 9, 2000.
(60) Provisional application No. 61/126,759, filed on May 6, 2008.

(51) Int. Cl. G06F 7/04

(52) U.S. Cl. 340/5.73

(57) ABSTRACT

Systems and methods for delivering goods and services involving use of locks that are programmed to permit limited entry under specified circumstances. A lock may be electronically programmed from a remote location in connection with an e-commerce transaction.

### CROSS REFERENCE TO RELATED APPLICATION(S)

This application is a continuation of U.S. patent application Ser. No. 10/258,187 filed Jun. 30, 2003 which claims priority from U.S. Provisional Application Ser. No. 60/119,003 filed Apr. 19, 2000 titled “Systems for Secure Delivery of Goods” and Ser. No. 60/203,079 filed May 9, 2000 titled “Systems for Secure Delivery of Goods”, each of which is incorporated by reference. This application also claims priority from U.S. Provisional Application Ser. No. 61/126,759 filed May 6, 2008 which is also incorporated by reference.

### FIELD OF THE INVENTIONS

The inventions relate to systems, devices, and methods of securely delivering goods and services, particularly goods and services procured through electronic communication.

### BACKGROUND OF THE INVENTIONS

For thousands of years people have sold and traded goods mainly through stores and markets. More recently, other sales methods have been used such as mail order and direct telephone sales. In the last several years the internet and world wide web have provided revolutionary new tools enabling a practically limitless number of new methods of exchanging goods and services. Consumers, retailers, wholesalers, businesses of all kinds can purchase goods and services from virtual internet stores, auctions, exchanges, bulletin boards, third party brokers, delivery companies, or other procurement parties, using specialized search engines, more efficiently and inexpensively then ever before. Statistics show internet business transactions are growing from about 15 billion dollars in 1999 to more than an estimated 300 billion in 2002, with no end in sight. The advantages of internet commerce are huge. People can shop without driving or waiting in line, without fighting traffic, paying for parking, or owning a car. People can shop through infinitely more stores and inventory in a finite period of time. People can shop around the world instead of being confined to a couple of stores that happen to be within driving distance.

Nevertheless, there are significant obstacles that prevent people from using the internet to purchase goods. Many people have reservations about buying goods over the internet because home delivery may be difficult to complete safely and securely. People are often away from their home. Leaving goods on a doorstep may not be safe or practical, particularly in dense urban areas, and especially when purchased goods are relatively expensive or massive in size. Many people live in apartments, condominiums, or dense housing developments where it is not feasible to leave new merchandise on a doorstep, and if no one is home during the day then there is no way to deliver goods securely during normal business hours. More and more people will experience this problem as cities grow and populations increase. People in this category are likely not to purchase goods over the internet without more secure delivery options.

Many internet vendors rely on third party delivery services such as United Parcel Service (UPS), Federal Express, or the U.S. Postal Service to deliver goods. These services either leave goods outside the premises or leave messages and return day after day trying to deliver goods when some one is home. This is highly inefficient and necessarily wastes time and drives up the cost of delivery service. If goods are not successfully delivered after several attempts then the goods may be shipped back to the original source canceling the sale, and frustrating the consumer with a failed e-commerce transaction.

Improved systems for facilitating secure delivery of goods and services will substantially remove or minimize obstacles that currently prevent many people and businesses from procuring goods and services electronically, and will significantly improve efficiency, and decrease costs of doing business.

### SUMMARY OF THE INVENTIONS

The inventions provide devices, systems, and methods for transferring goods and rendering services securely. Devices include locks that can be programmed remotely to permit entry to premises such as a locker or a building. A lock may be unlocked by entering a transaction-specific entry code for the purpose of delivering or picking up goods. A transaction-specific entry code may be communicated to a lock from a computer in conjunction with an e-commerce transaction. The lock also may communicate entry information remotely to a personal computer inside a premises, or to a purchaser outside the premises, or to a vendor, or a delivery party, to confirm, record, or reprogram delivery parameters.

The inventions include lock devices that may be programmed to interact with purchasers, vendors, and/or delivery persons. A lock device may be equipped with radio paging, cellular, or other radio receiver devices to facilitate communication between parties to a transaction, and to record data relating to delivery or pick-up of goods. A lock device may be associated with a box for containing a key to another lock, or a locker, or a room or building.

Another aspect of the inventions provides software for carrying out procurement, delivery, and/or transfer of goods. A vendor may use delivery programs in conjunction with “check-out” routines for carrying out a sale of goods online. Other programs are executed on a purchaser's personal computer for dictating, and communicating entry criteria, for example, to a vendor and to an e-lock. Personal computer software may also maintain records of executed transaction data, as well as interact with other electronic devices in or around a premises to monitor delivery activity. The inventions also provide programming of a microprocessor connected to a lock, for example, an e-lock.

Other aspects of the inventions provide systems including a network of electronic devices programmed to carry out cooperative routines for transferring goods. For example, a personal computer, and an e-lock may be programmed to operate together in connection with a procurement and delivery transaction. Numerous other possible combinations of computers, locks, and software that can be operated by purchaser, vendor, and/or delivery person are also included in the inventions.

The inventions also provide numerous new business methods that can be carried out using the devices and systems described above to transfer goods and render services securely between parties.

### DEFINITIONS

A “lock” is a mechanism that physically blocks entry to a location, for example, the interior of a premises, box, or locker. A lock typically uses a latch device that can be moved between a locked position and an unlocked position. Movement of a latch device may require input of a code, referred to as an “unlock code”, such as a secret combination of letters and/or numbers, or a particular profile on the stem of a key.

An “e-lock” is a lock that is at least partially controlled electronically by a lock server located remotely from the e-lock. An e-lock may be equipped with a one-way or two-way transceiver for receiving and/or transmitting information concerning an unlock event. An e-lock may be programmed remotely.

A “lock server” is a computer programmed to communicate remotely with a lock. The lock server may also be programmed to coordinate goods procurement over the internet.

An “unlock event” is the act of unlocking a lock, for example, the lock on a lock box.

A “box” or “locker” is an enclosure for containing one or more items such as a key for another lock, or goods being delivered or picked up. A box is typically associated with a lock or e-lock that must be unlocked to gain access to the contents of the box. Such a box may be referred to as a “lock box” or “e-lock box”. A lock box may hold a key to another lock. The key may be securely tethered to the box so that it cannot be taken away from the vicinity of the lock. The lock box can be opened by using a special key or combination. Lock boxes may be used in the construction industry to permit entrance by subcontractors, and in the real estate industry when a house is for sale so that realtors can get into the house to show it without having to obtain a separate copy of the owner's key.

A box or locker may also be referred to as an “enclosure”. A secure enclosure may be located at a residence, business, or other dwelling for receiving delivery of goods. An enclosure may be a box made of steel, metal, wood, or plastic. An enclosure may be anchored to the ground or a building so that it cannot be easily carried away. An enclosure may be a dwelling or premises.

“Goods” are any tangible items including but not limited to all types of new and used things that are available for procurement over the internet, or some other type of telephone connection.

“Goods transfer” may mean movement of goods from one place to another place, or exchange of possession of goods from one party to another party. The act of transferring goods may be referred to as a “goods transfer event”. “Goods procurement” means to bring about, acquisition of goods.

An “instruction packet” is a set of parameters concerning an unlock event transmitted from a lock server to an e-lock. An instruction packet may include a transaction-specific entry code, a time window for delivery, a personal identifying code, or other parameters relating to a specific goods or service delivery event.

“Premises” mean any building or dwelling including but not limited to a house, apartment, condominium, business, office, any part or combination of these, or any other type of enclosed habitable structure.

A “transaction-specific entry code” is an unlock code specially selected, assigned, and communicated to a lock for limited entry use in connection with a particular transaction. A “transaction” is an agreement between parties to exchange goods or render services. For example, an e-lock may be programmed to unlock upon receipt of a transaction-specific entry code for a particular goods transfer event. A transaction-specific entry code may be used to transfer goods at the final delivery destination or at an intermediate premises along a delivery route. Use of a one-time transaction-specific entry code substantially avoids concern about a given number being circulated and later misused.

A “deliveror-specific entry code” is a an unlock code specially selected, assigned, and communicated to a lock for limited entry use by a particular vendor. For example, one entry code may be assigned to a grocery delivery service.

A “personal indentifying code” is a code that indicates the identity of a person such as a delivery person. For example, an e-lock may be programmed to require input of a personal identifying code, in addition to a transaction-specific entry code, prior to being unlocked. A personal identifying code may be a combination of numbers and/or letters, or may be an inherent physical characteristic such as a fingerprint.

The “internet” comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages.

Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

### DESCRIPTION OF THE FIGURES

FIG. 1 is a schematic view of a system for procuring goods from a vendor.

FIG. 2 is a schematic view of an electronic locker device.

FIG. 3 is a flow chart of an electronic processing system used to carry out goods procurement and delivery.

FIG. 4 is a schematic view of another system for procuring and delivering goods.

FIG. 5 is a schematic view of another procurement system in which an e-lock is used to pick-up goods.

FIG. 6 is a schematic view of another system for transferring goods.

FIG. 7 is a schematic view of another system for transferring goods.

FIG. 8 is a front schematic view of an e-locker for receiving goods at a premises.

FIG. 9 is a schematic view of a procurement system providing delivery to an apartment complex.

### DESCRIPTION OF THE INVENTIONS

The inventions provide hardware, software, systems, and methods for transferring goods securely, preferably with a high degree of automation by using electronic communication devices. Preferred embodiments of the inventions utilize e-locks that may be programmed remotely according to criteria that suit a particular transaction. E-locks may take the form of an electronic lock box, or may be a computerized lock built into a door or a building. E-locks may be used to deliver and/or pick-up goods. One or more e-locks may be accessed in the course of a single transaction.

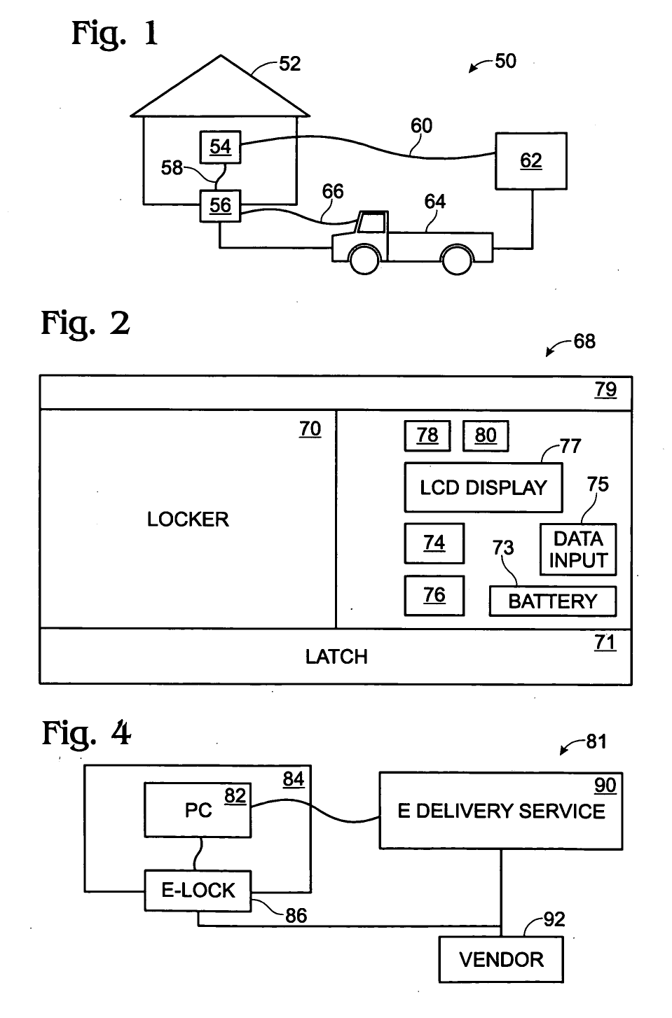

FIG. 1 shows a system 50 for procuring goods. Premises 52 has computer 54 and lock 56. A communication link 58 enables transfer of information between computer 54 and lock 56. For example, premises 52 may be a private residence; computer 52 may be a PC equipped with a modem; and lock 56 may be part of an e-lock box that is secured to the front door of premises 52. Communication link 58 may be created by accessing a paging (radio) receiver in lock 56. Lock 56 may also have a transmitter for sending information back to computer 52. A person in premises 52 may use computer 54 to establish an internet connection 60 with vendor 62. For example, vendor 62 may have a web site that offers goods for sale. A person in premises 52 can select goods for purchase on a web site of vendor 62 via computer 54. Computer 54 then selects, assigns, and communicates a transaction-specific entry code to vendor 62 and to lock 56.

The transaction-specific entry code may be part of an instruction packet including other parameters relating to delivery of the goods purchased in the transaction. For example, the instruction packet may specify a time window for delivery. The instruction packet may indicate that a personal identifying code of the delivery person must be entered prior to unlocking lock 56. The instruction packet may specify that only a particular delivery company, or class of delivery persons be permitted entry. Alternatively, the delivery packet may specify that certain delivery companies, classes, or persons not be permitted entry under any circumstances. The instruction packet may specify that the delivery person be required to enter an exit code, and that the duration of the stay be limited to an appropriate time window such as one to three minutes. Lock 56 may be equipped with a motion detector to monitor any further movement of the door or the lock after passage of the time window. Lock 56 may have a clock so that it can record the time of an entry or an unlock event. Lock 56 may have a transceiver and be programmed to transmit information regarding an unlock event back to computer 54.

Vendor 62 provides the transaction-specific entry code, and any other necessary information to delivery service 64 so that delivery service 64 can satisfy all of the parameters specified in the instruction packet transmitted from computer 54 to lock 56. Lock 56 may also be equipped to receive transmissions 66 from delivery service 64, for example, so that delivery service 64 can verify that lock 56 is receptive to delivery at a particular time.

FIG. 2 shows an example of an e-lock. E-lock 68 has an enclosed locker compartment or box 70. Locker 70 may be a relatively small housing for containing a key to another lock, such as in a conventional lock box. Alternatively, locker 70 may be any size, for example, the size of a typical athletic locker, or may be an actual room or building such as a shed, garage, storage unit, or house. Latch device 71 limits access to locker compartment 70. Latch 71 must be actuated to gain access to locker 70. For example, there may be a knob, button, or handle that can be manipulated to unlock latch 71 when specified entry criteria have been satisfied. Enablement of latch 71 is controlled by electronics unit 72.

Electronics unit 72 preferably includes a communication device such as a paging, cellular, or other type of RF receiver. Compact communication devices are described in U.S. Pat. No. 5,192,947 and No. 5,815,557 which are hereby incorporated by reference. Electronics unit 72 is powered by battery 73 and includes microprocessor 74 that is programmed to determine, based on instructions from a remote lock server, whether entry criteria are satisfied, and therefore to allow operation of latch 71 and access to locker 70. Data input mechanism 75 such as a keypad is provided to allow a user to enter transactional data, for example, a transaction-specific entry code. Data input mechanism 75 may also sense sounds, visual images, bar codes, etc. by using devices such as sound sensors or CCD arrays. Electronics unit 72 includes clock 76 so that microprocessor 74 can process instructions relating to a specified time window for permitting access to locker 70. LCD display 77 may be used to communicate messages to a user concerning a failed entry attempt, or an instruction concerning a particular delivery, or some other type of prompt. Receiver 78 uses antenna 79 to receive messages from a lock server such as a personal computer inside a premises. Transmitter 80 permits electronics unit 72 to send information back to the lock server, for example to report data relating to a particular entry. Transmitter 80 may also be used to send information to another party such as a vendor, delivery person, or to a phone or computer possessed remotely by the purchaser.

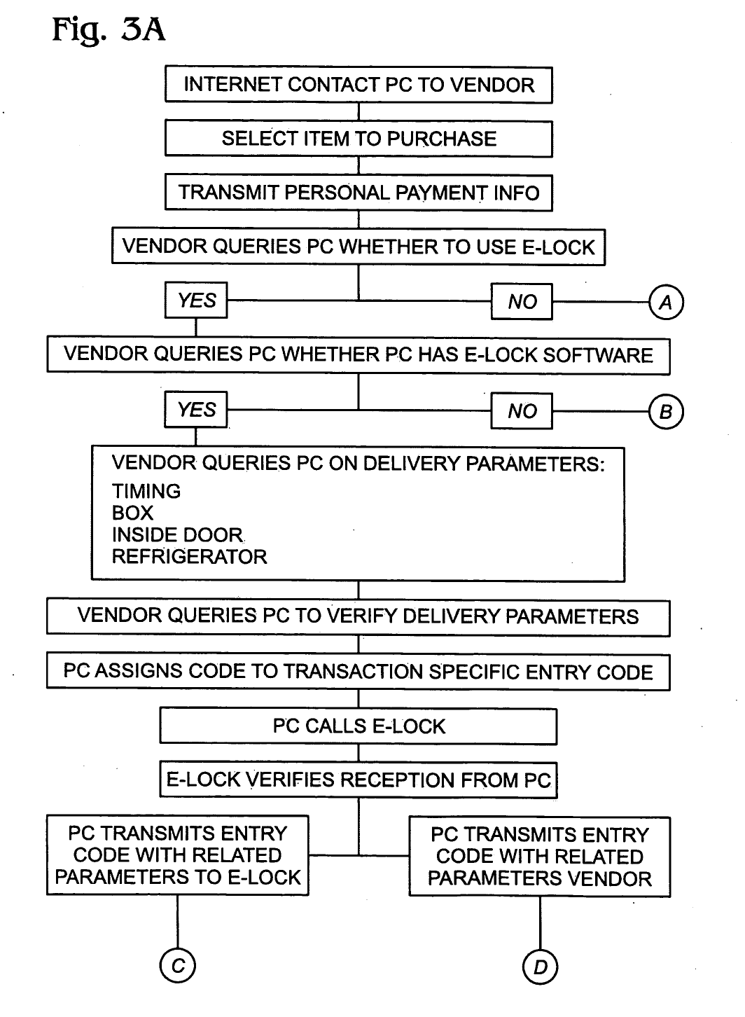

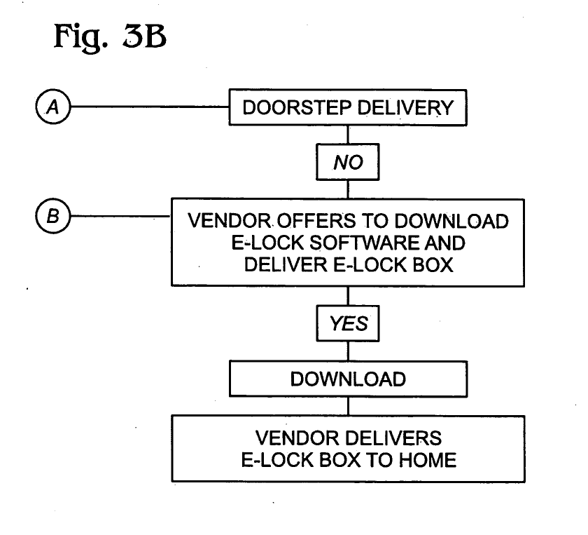

FIG. 3 is a flow chart illustrating a processing routine involving a personal computer (PC), an exterior door lock, and a remote vendor, such as 54, 56, and 62 in FIG. 1. First, an internet connection is established between a personal computer and a vendor's web site. The customer shops on the web site and eventually selects one or more items to purchase. When the customer is finished shopping, the vendor queries the customer to enter personal payment information such as a credit card number, expiration date, delivery address, etc.

Additionally, vendor queries customer whether the customer desires goods delivery via an e-lock system. If customer answers NO, then vendor delivers the goods to customer's doorstep or by some other traditional method.

If customer indicates that e-lock delivery is desired, then vendor queries customer regarding delivery parameters, for example, timing for delivery; whether to access an exterior locker, front door, garage, or refrigerator. Vendor then queries customer to verify the selected delivery parameters.

Customer's PC then assigns a transaction-specific entry code to the transaction. PC calls e-lock. E-lock transmits verification of reception to PC. PC transmits the entry code and all other related parameters in an instruction packet to e-lock. PC also transmits the entry code to vendor.

Vendor then transmits the entry code and any other necessary delivery parameters to the delivery service. The delivery service delivers the goods and complies with all specified parameters including entry of the entry code into e-lock and placement of the goods securely in the premises or other designated secure enclosure. Once the delivery has been made, the entry code is disabled so that it cannot be used to enter the premises a second time. E-lock records data concerning the delivery such as when the delivery was made, who made the delivery, and how long the delivery person was in the premises. E-lock then transmits the delivery information back to the PC where a log of delivery information is maintained for future reference.

Another goods delivery system 81 is illustrated in FIG. 4. PC 82 is located inside premises 84. E-lock 86 is stationed at an exterior door of premises 84. PC 82 and e-lock 86 are configured to communicate, for example via radio signals. E-lock is equipped with a radio receiver to receive instruction packets from PC 82. A person in premises 84 can access the web site of a delivery service 90 such as KOSMOS.COM, and place an order for delivery of goods. The delivery service queries the person in premises 84 to enter payment information, and also to indicate whether delivery should be through an e-lock system. If so, then a similar software routine as the one shown in FIG. 3 is used to acquire delivery parameters and to assign and communicate a transaction-specific entry code.

Delivery service 90 then sends an agent to vendor 92 to pick up goods. Agent then transports the goods to premises 84. Agent accesses a secure delivery location via e-lock 86 by satisfying all of the delivery parameters specified in the instruction packet conveyed from PC 82 to e-lock 86. In a modification of system 80, PC 82 can route payment information directly to vendor 92, and e-lock entry information directly to delivery service 90. It is also possible for vendor 92 to use an e-lock system to transfer goods to delivery service 90.

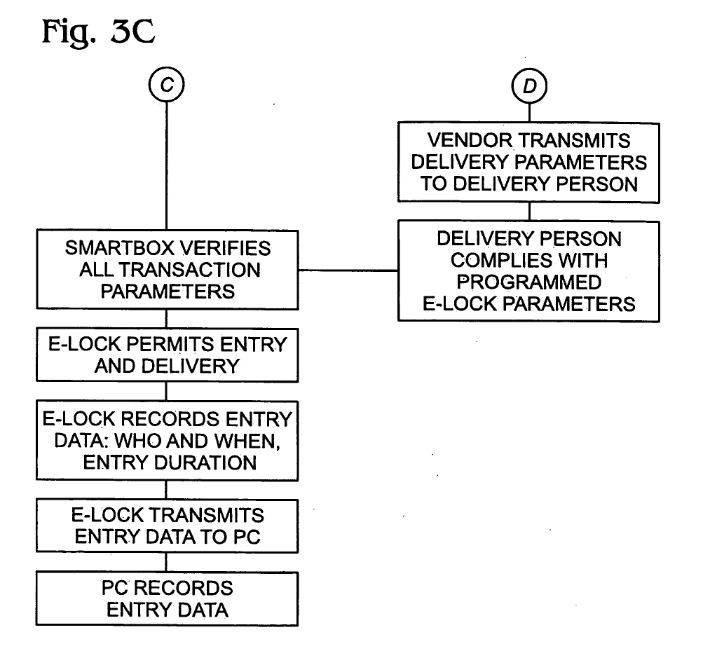

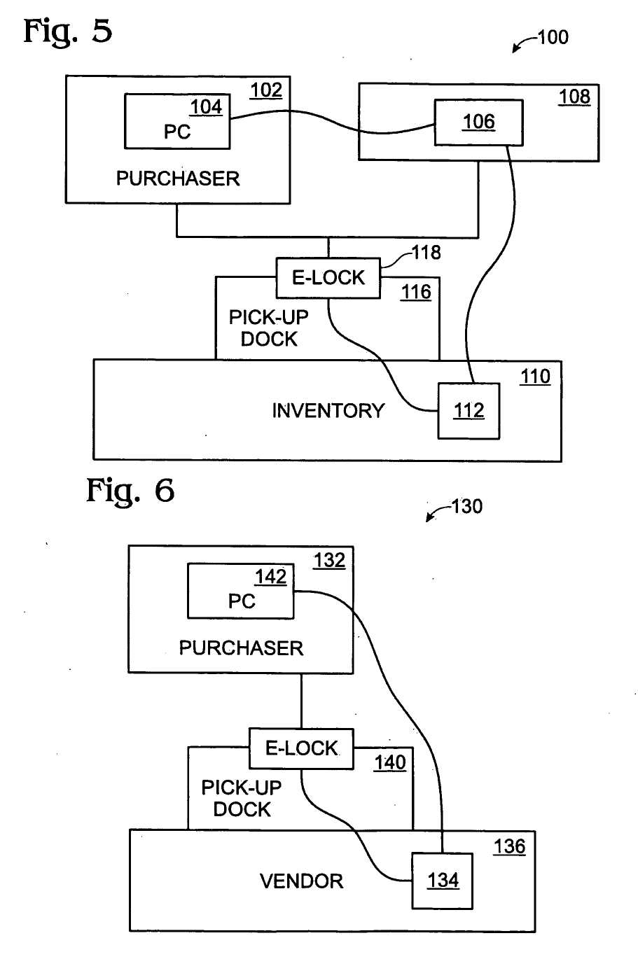

Another goods procurement system 100 is illustrated in FIG. 5. Purchaser 102 executes a purchase transaction through PC 104 from web site 106 of procurement party 108. Procurement party 108 may be primarily a goods delivery company that obtains goods from other companies. Procurement party 108 may also be a retailer that sells inventory located at another site. Upon receiving an order from purchaser 102, procurement party 108 communicates the goods request to third party 110. Third party 110 may be a warehouse that holds inventory and handles shipping and receiving for procurement party 108. Alternatively, third party 110 may be a retailer that has a business arrangement with a delivery company such as KOSMOS.COM. The communication from procurement party 108 to third party 110 may be made by internet transmission between computer 106 and computer 112, or by verbal telephone communication, or some other communication means.

Preferably, computer 106 is programmed to automatically set up the transaction by confirming with third party 110 that the requested item is in stock, and verifying availability before finalizing the order with purchaser 102. Once the order is finalized with purchaser 102, then computer 106 arranges a goods pick-up protocol from third party 110 through communication with computer 112. Computer 112 is programmed to set up a goods pick-up routine similar to the delivery protocols described above. For example, as shown in FIG. 5, third party 110 has an enclosed pick-up dock 116 that has an e-lock 118 that controls entry to pick-up dock 116. Computer 106 communicates a goods pick-up request to computer 112. Computer 112 transmits an instruction packet to computer 106 specifying an e-lock entry code, and any other pertinent parameters or limitations on the pick-up protocol. The entry code may be transaction-specific or deliveror-specific. The instruction packet may specify the time when the goods can be picked up, and/or that a personal identifying code of the person picking up the goods is required before entry. The instruction packet may also specify where the goods will be located in the delivery dock or how the goods will be marked. The pick-up person may be required to pass the goods through a bar code scanner before exiting the pick-up dock with the goods. Computer 112 communicates the instruction packet to e-lock 118.

Procurement party 108 then travels to pick-up dock 116, unlocks e-lock 118 by complying with all entry parameters specified in the instruction packet. Procurement party picks up the purchased goods and delivers the goods to purchaser 102. The goods may be delivered to purchaser through an e-lock system, as described and shown in FIG. 1. Thus, it will be appreciated that a single purchase transaction may utilize more than one goods exchange controlled by e-locks, and that e-locks may be used for goods pick-up as well as goods delivery. Procurement party 108 may use one set of e-lock entry parameters to pick-up goods, and a separate set of e-lock entry parameters to deliver goods. The entry code for goods pick-up may be procurement party-specific, while the entry code for delivery to the purchaser's premises may be transaction-specific.

FIG. 6 shows another goods procurement system 130 that enables a person to purchase goods from a vendor, and pick-up the goods through an e-lock security device. Purchaser 132 accesses and purchases goods from the web site 134 of vendor's 136. Vendor's computer is programmed to assign and communicate a transaction-specific entry code to purchaser 132 along with any other entry limitations or parameters according to the principles described above. Vendor 136 then transfers the purchased goods to enclosed pick-up dock 140. Pick-up dock 140 may also have a plurality lockers, each lock being equipped with a dedicated e-lock. The instruction packet conveyed to purchaser's PC 142 indicates which locker on vendor's pick-up dock 140 to access, the transaction-specific entry code, and the time when the goods can be picked up.

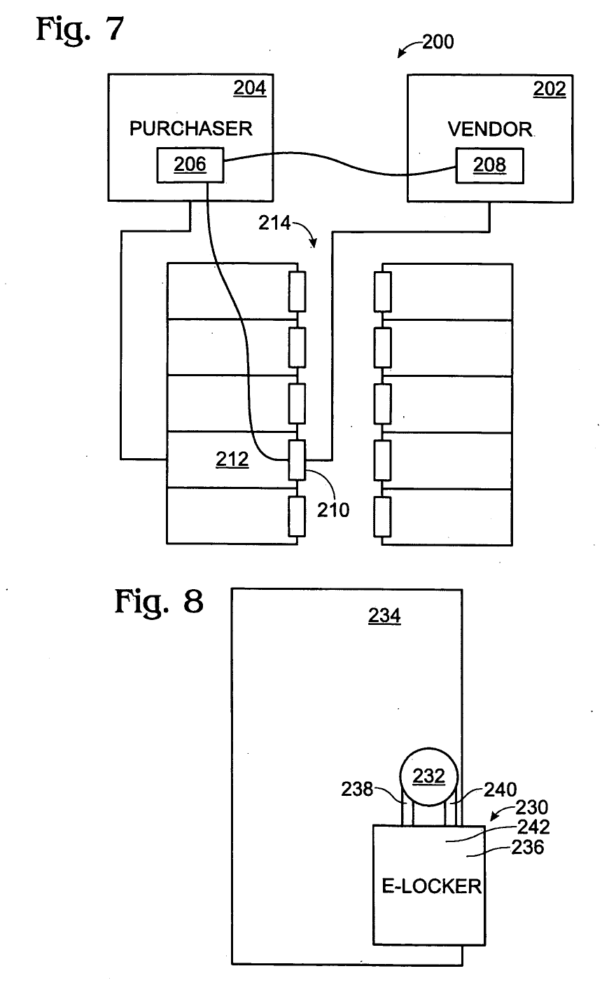

FIG. 7 shows another system 200 for transferring goods from a vendor 202 to a purchaser 204. Purchaser 204 uses home computer 206 to purchase a product from vendor's web site 208. As part of the transaction, computer 206 assigns a transaction-specific entry code and communicates the code along with any other appropriate entry parameters in an instruction packet to e-lock 210, and to vendor 202. E-lock 210 may be located on a locker space or room 212 in a storage or delivery facility 214. Purchaser 204 may rent delivery locker 212 similar to the way people rent private space in storage businesses. Purchaser can select a delivery facility 214 that is located within a convenient proximity of purchaser's home or work. Purchaser 204 can shop and buy goods anytime. Vendor can deliver goods securely anytime. Purchaser can pick-up goods from private locker 212 anytime. Locker 212 may be equipped with a refrigeration unit to preserve perishables such as food. Purchaser may contact e-lock to confirm that goods from a particular transaction have been delivered before traveling to locker 212. Alternatively, e-lock 210 may send an email to computer 206 when a delivery is made so that purchaser 204 knows that the goods are available for pick-up. The same system can also be used in reverse to send goods back to a vendor for replacement, repair, or refund.

FIG. 8 shows an e-locker 230 suspended from a doorknob 232 on a front door 234. E-locker 230 has a container portion 236 and a bar portion 238. An e-lock (not shown) inside container portion 236 locks bar portion in a closed loop around a doorknob or through some other fixture near door 234. A code input device is provided according to principles described above so that a delivery person can enter a secret code, preferably a transaction-specific or vendor-specific code, thereby allowing entry and delivery of goods to container portion 236. One mechanism for achieving this is for bar portion 238 to slide relative to container portion 236 similar to unlock-and-slide mechanisms used in anti-theft devices for steering wheels on cars. For example, bar piece 240 may engage and prevent opening of front panel 242 when the e-lock is locked. When the e-lock is unlocked, bar piece 240 may disengage front panel 242 thus allowing front panel 242 to pivot and open allowing access to the interior of container portion 236.

A goods delivery system may be adapted for use in an apartment or condominium type of complex in which there is a common front gate or door that must be entered first before accessing doors to individual premises. Individuals who have premises inside the common building may locate anchored individual e-lock boxes or lockers outside the common door. The e-lock box may contain two keys, or a common e-lock outside the main building may be used by those who live inside the building. Goods may be left in the lobby, or personal e-lock may be located by or on individual doors inside the building.

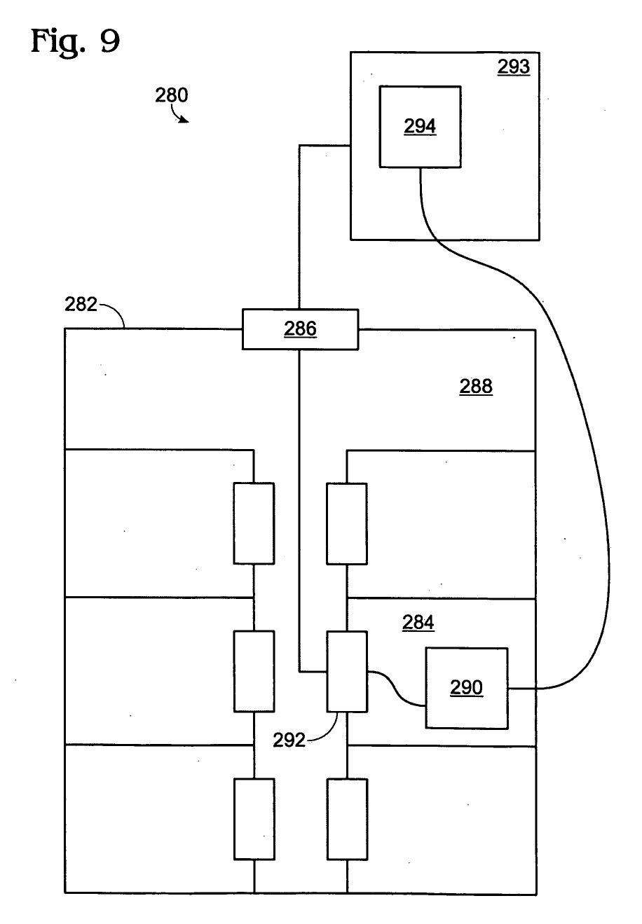

FIG. 9 shows an example of a procurement and delivery system 280 for use in an apartment or condominium complex 282. Apartment complex 282 has personal apartment units 284, e-lock 286 on or around a front door providing access to a lobby or interior common area 288. Apartment unit 284 has a personal computer 290 and a personal e-lock 292 on or around a personal front door. An occupant in apartment unit 284 purchases an item from vendor 293 by accessing vendor's web site 294 through computer 290. E-lock 286 has a general entry code that occupant programs into computer 290. Computer 290 may then assign a transaction-specific entry code for accessing e-lock 292, and also may provide the general entry code for accessing e-lock 286. Alternatively, computer 290 may assign two transaction specific codes, one for accessing e-lock 286, and the other for accessing e-lock 292. Computer then communicates both codes to vendor 294, the general front door code to e-lock 286, and the private unit entry code to e-lock 292. Many different types of e-lock devices may be used in the present inventions. Radio transmitting systems have been used frequently in the field of electronic security systems. For example, in a garage door opener, a radio transmitter is used to relay instruction signals to a receiver unit, causing the receiver unit to activate a door opening mechanism. Radio data transmission is sometimes used in home security systems to relay data from motion, continuity, vibration or other detectors to a central monitoring unit. U.S. Pat. No. 4,766,746 and No. 5,815,557 involve locks and keys that can be equipped with radio receivers to provide a secure entry system with remote programming capabilities. Radio is sometimes used outside the security field to relay reprogramming instructions to remote units. U.S. Pat. No. 4,525,865 and No. 4,910,510, for example, disclose pagers and other radios whose operational characteristics can be reprogrammed remotely by radio. U.S. Pat. No. 4,543,955 and No. 4,958,632 disclose cardiac pacemakers and other implantable devices that can be reprogrammed via use of radio. U.S. Pat. No. 4,713,661 discloses an annunciator system for buses wherein a sequence of bus stop information can be programmed into the system via radio. U.S. Pat. No. 5,016,273 discloses a videocassette recorder that is equipped with a paging receiver to provide a number of features, including remote VCR programming. The patents discussed above are incorporated by reference.

Many different types of businesses may use variations of inventions described above. For example phone companies are offering cellular phones that provide numerous computer capabilities. Cellular phone devices can easily be designed to carry out e-commerce, and to remotely program one or more e-locks to facilitate a transaction, where the cellular phone is similar to the personal computer in the systems and methods described above.

The inventions may also be used by e-commerce companies such as AMAZON, E-BAY, and thousands of others, as well as delivery companies such as UPS, Federal Express, WEBVAN, and KOSMO. Inexpensive e-lock boxes may be sold or even given away to help new customers have more confidence in e-commerce security, particularly for customers who live in dense urban areas. Savings in delivery efficiency, minimizing missed deliveries, and increasing internet orders, could easily justify the cost of giving away free devices.

E-lock systems described above may also be used to procure and render services. For example, a person may order a service from a web site and request that the service be rendered when no one is home. Such services may include cleaning, laundry and dry cleaning, carpet cleaning, furniture cleaning, repair or refinishing, painting, plumbing, electronics and appliance repair, decorating, designing, cooking, renovating, and remodeling, among others.

The transfer systems described above may also be advantageously combined with camera devices that automatically create a video record of a person entering a premises to deliver goods or to render services. For example, inexpensive video equipment is currently available for monitoring a premises remotely by internet communication. XANBOO.COM offers video security equipment for this purpose. The e-lock systems described above can easily be combined with video monitoring equipment to generate a video record of a delivery person or service person inside the premises. One or more video recording devices may be located inside the premises and/or outside an entrance to a premises. The video recording devices may be turned on initially in response to an attempted code entry into an e-lock. Alternatively, the video devices may turn on in response to sound or motion sensors. The video devices may automatically run for a set period or may run until another event occurs such as an absence of noise for a continuous period, as detected by a sound or motion sensor.

Preferred embodiments of the inventions have been described and illustrated. However, many modifications can be understood and carried out according to general principles of the inventions as set forth in the claims below. For example, most of the examples described above have been related to transactions in which goods are procured over the internet. The inventions may also be used to complete verbal telephone sales transactions, or virtually any sales of goods that require delivery of goods to a home or business premises. Transaction-specific entry codes may be provided by a vendor instead of the purchaser. E-lock systems may be used by services that pick-up household items for cleaning or repair, and subsequent return.

Delivery may be carried out with a simple combination lock. The purchaser may be prompted at the time of an internet transaction to provide the combination for the lock. A lock box may have a single combination that is given out by the purchaser via the internet to the vendor at the same time that the transaction is executed, when payment information is provided. In this case the lock box code can be constant and there is no need for the lock box to be programmable. The lock box combination can also be programmable by the purchaser so that the home owner can simply change the combination from time to time. The inventions may also employ any of the features described above but be employed in a dedicated locking mechanism for an enclosure such as a safe, box, or refrigerator. For example, a refrigerator unit may be placed outside of a home or in a garage.

An e-lock may report delivery status to a purchaser. For example, the purchaser can determine whether a particular entry has been made by querying whether the transaction specific entry code has been used. An e-lock can be integrated with a phone/voice mail system or portable computer, so that a purchaser can find out from a remote location whether an item has been delivered.

An e-lock system may be used on a garage door to provide access to a spacious secure enclosure without home access. A dedicated refrigerator may be situated in the garage or shed for receiving grocery items.

An e-lock box may be used in conjunction with a chain lock to allow a delivery person to open the door enough to deliver packages, but not enough for a person to enter the premises. A lightweight net or cage-like enclosure may be positioned immediately inside the door so that the delivery person may not enter the premises more than a few feet.

An e-lock device may have a scanner that scans a bar code on a package. The bar code data input may be in addition to the entry code, or may serve as the entry code itself. If the bar code matches the transaction number then the lock opens and entry is permitted.

Correct code entry to the lock box may give the purchaser's cell phone number to the delivery person. The delivery person can then call the purchaser to receive delivery instructions.

An e-lock may print a receipt or provide a receipt code to the delivery person so that the delivery person has a record of the delivery. An e-lock may be turned on and off. The purchaser may turn the lock off when home, to receive delivery personally.

A box may be vendor-specific. The vendor box keeps track of delivery status. Vendor communicates remotely with the box to track delivery of goods. Vendor knows when a delivery was made and by whom. The box may include any of the features described above, programmable transaction-specific entry code, link to home PC, etc., or may simply be a delivery record keeping and tracking device.

An e-lock may be configured to receive an entry code in many different forms. For example, the code may be substantially invisible to the delivery person. The code may be carried in an electronic unit that transmits a unique sequence of sound signals at varying frequencies. The delivery person activates the unit to convey the audio-code to the e-lock. The same principle can be achieved with a radio transmitted code or an optical code, or any other type of device that allows a delivery person to transmit and enter a transaction-specific entry code to an e-lock without actually having knowledge of the code itself. For example, the delivery person may carry a cellular phone that allows a simple dial-up routine in which: delivery person calls vendor, or vendor's agent; identifies the transaction; permits transmission of an audio-code from vendor or vendor's agent, over the phone, to the e-lock, thereby permitting entry and secure delivery.

### EXAMPLES

### 1. Vendor Controlled Personalized Electronic Key Vault

People have suggested using electronic lockers for delivering goods. However, these devices are too complex and expensive for many people. There are many potential online purchasers who cannot afford to install an electronic locker system as proposed in U.S. Pat. No. 5,774,053 (incorporated by reference). Another problem with personal locker devices is that some people are not sophisticated enough to understand, operate, and manage a computerized personal security device. Another problem with personal locker devices is that many home premises do not have places for mounting or positioning exterior lockers or refrigerators (for example, apartments). Consequently, many potential online shoppers cannot be assisted by a purchaser controlled electronic locker.

An inexpensive delivery system alternative to a purchaser-controlled computerized locker system is provided and controlled by a vendor. The system gives the vendor limited access to a key, enabling entry to an enclosure for delivering goods. The '053 patent teaches away from providing vendors with keys for privacy and security reasons. However, this example provides ways of limiting or monitoring use of a residence key so that a purchaser is sufficiently confident that the key will not be misused. A purchaser already has sufficient confidence in a vendor and the vendor's website to entrust the vendor with a personal credit card number.

Once the customer develops confidence in the vendor controlled key vault, the customer is likely to increase online business through the vendor. Ongoing presence of the vendor's lock box along with vendor's branding around a building entrance also serves the purpose of advertising for the vendor's service and shows the vendor's commitment to secure delivery. The vault also has the effect of encouraging business particularly of more expensive and valuable items that raise bigger concerns regarding theft. The vault also provides significant savings from fewer failed and returning delivery attempts. The vault system also will help to create a significant population of new online customers, particularly people who live in premises where door-step or in-person delivery are not feasible, for example, apartments, condominiums, dense urban areas, dormitories, etc. These important business developing benefits for the vendor will more than justify the vendor's investment and expense in manufacturing and distributing vaults to customers, at little if any cost to the customer. The vendor may come up with incentive approaches to encourage new business and use of the vault system

In this example, a primary vendor provides a lock box or electronic key vault to a customer. The customer may purchase the vault. Alternatively, the vendor may give or lend the vault to a customer who does more than a threshold amount of business with the vendor. The electronic key vault box basically has a key chamber, a linkage device, a controller, a transceiver, and a bar code scanner or other type of transaction-specific code entry device such as an alphanumeric keyboard. The lock box may be referred to as a “vendor controlled personalized electronic key vault”.

In this description, a “key vault” or “key chamber” is intended to refer to a small closed compartment dimensioned for containing a key as opposed to a container intended for holding goods. In this description a container for holding goods may be referred to as a “locker”. The key chamber is a compartment with a moveable panel or port having an opened and closed position. The chamber is made of a material such as metal or hard plastic which cannot be easily cut or broken open. There are many examples of lock boxes with key chambers which are designed to resist attempts to break into the chamber. The chamber is generally small, sufficiently large enough to contain a key but small enough to fit in or around small places in the vicinity of a door to an enclosure such as a building.

The key chamber is connected to a linkage device that allows the vault to be connected to a fixture such that the vault may not be removed from the enclosure vicinity without a key or combination. For example, the linkage device may be a metal loop dimensioned to hang around a door knob or around an opening in a railing, the handle of an automobile, etc.

The controller includes a computer program for receiving a transaction specific entry code, physically permitting opening of the chamber, and instructing the transceiver to send messages to the vendor and/or the purchaser concerning delivery events.

The transceiver may be similar to devices used in cell phones as described above. The transceiver enables the vault to receive and transmit information preferably between the vault and the vendor. The vendor may retain the main access number (i.e. phone number) as confidential information, so that no other party can communicate with, program, or control access to the vault, except perhaps for the customer. The vault may be programmed to allow customer access

A transaction specific entry code mechanism is preferably a barcode scanner because packages already typically carry transaction specific barcodes for identification purposes, and barcode scanners are inexpensive and dependable. However, other types of code entry devices may be used in accordance with principles already discussed above.

The key vault may be utilized as follows. A purchaser purchases goods online from primary vendor's website. Vendor may recognize via password that purchaser already has and uses one of vendor's electronic key vaults. If not, vendor may explain the option of using a key vault and may offer to deliver a vault for future delivery purposes. Vendor may require a rental fee, a one time purchase fee, or a prerequisite sales level.

Purchaser may elect to receive a vendor controlled personalized key vault, in which case vendor delivers a vault with instructions for installing the vault near a door to premises associated with a standard delivery address. Vendor may ask purchaser for other delivery parameters, preferred times, messaging preferences, etc. The vault may initially go through a calibration test in which the purchaser scans a barcode received with the vault. The vault transmits the barcode to the vendor, providing notice that the vault is installed and ready for use. A more intelligent vault may include a gps allowing the vault to inform the vendor where the vault is located. The gps feature also has the advantage of automatically providing a delivery location to the vendor or a delivery person.

If purchaser desires delivery via vendor's personalized key vault, then vendor assigns a transaction-specific code to the transaction, the code being preferably presentable in a barcode format. Vendor transmits the code to purchaser's vault. A delivery person then delivers the package to purchaser's premises. The barcode scanner on the vault is used to scan the barcode on the package, allowing one-time access to a key in the key chamber, thereby accessing the enclosure for delivering the goods. When the barcode is recognized by the vault controller, access to the key chamber is permitted and a message is transmitted to the vendor that the package has reached its destination. Vendor then sends a message to purchaser that the goods have been delivered, the time of delivery and any other important details. The purchaser's message is sent preferably via email, text message or any other suitable means of communication.

The delivery person may also have a personal identification code (barcode) which must be scanned in prior to scanning the barcode on the package. The information packet transmitted from the vault to the vendor may include identification of the package, identification of the delivery person, the time of delivery (determined by the timing of the message or by a clock included in the vault controller).

The vault may be used with many different kinds of enclosures for receiving goods. For example, a vault may contain a key for a door on a house, or an apartment. The vault may contain a key for enabling entry to a locker. The vendor may sell or give away lockers for use with a vault, as described above. The locker may be specially dimensioned for specific standard sized goods such as books and CDs. The vault may contain a key for a garage, an automobile or any other type of lockable compartment.

The vendor's e-vault system may require service from a cellular phone company such as Verizon, AT&T, Sprint, etc. Vendor may contract with a phone company which provides phone service in particular geographical areas for charges per vault, per time period, per call, etc. The phone service may also serve as a seller of e-vaults for use through vendor's controlled network.

In an alternative example, phone company may be the primary administrator of the e-vault system. In this example, phone company sells e-vaults, and controls e-transaction delivery in accordance with the principles discussed above. Vendors may offer e-vaults on their websites and provide links through phone company such that transaction specific codes are communicated to e-vaults, goods are securely delivered, and vendor and customer are given notice of delivery status. In this example vendor may query phone company for transaction specific delivery code (preferably a barcode) which then goes on the package so carrier can access an enclosure via the key from the key chamber.

### 2. Sub-Vendor Example

A primary vendor who has implemented the vault system described in (1) may then adapt the system to facilitate delivery of goods from other vendors for a commission. There are literally tens of thousands of potential on-line vendors who may want to take advantage of vendor's vault system for delivery. In this example, a sub-vendor sells goods to purchasers through the sub-vendor's website over the internet. Vendor's branded vault delivery system is presented on sub-vendor's website. If purchaser elects to use primary vendor's vault delivery system for delivery, then sub-vendor forwards the transaction code to vendor, which will be presented as a barcode on the product packaging. Primary vendor communicates the barcode to purchaser's personalized vault. Deliverer arrives at the delivery location and uses the scanner on the vault to scan the barcode on the package, permitting deliverer to access the key chamber, use the key to open an enclosure such as a door to a dwelling, a garage, or a locker, and deliver the goods. Deliverer then replaces the key into the key chamber of the vault. The vault communicates via wireless connection, preferably radio signal, to primary vendor that the goods have been delivered. Primary vendor then informs sub-vendor and purchaser that the goods have been delivered, and may also communicate other information such as the time of the delivery, identification of the delivery person, or any other details. For this service sub-vendor pays vendor a commission. Vendor benefits from advertising on sub-vendor's website and gains brand recognition.

Alternatively, vendor may license sub-vendor to administer delivery to the vault system without communicating through vendor. Vendor may provide vaults for sub-vendor to distribute, and contact numbers for vaults in the field enabling sub-vendor to communicate with the vaults for carrying out transactions and secure delivery.

### 3. Broker Controlled Personalized Electronic Vault System

This example would be carried out by companies such as eBay or Craig's list.

This option is similar to (1) except broker transmits a bar code to seller. The bar code may be printed out and attached to the package. Broker may prevent seller from knowing the physical address of purchaser so that seller may not use the barcode to enter purchaser's premises without permission. Carrier may determine the address by scanning the barcode on the package and communicating with broker. Broker provides the delivery address to carrier who then delivers the package as in (1). Delivery notification is communicated to broker who informs purchaser and seller that the delivery has been completed along with any other desired details.

### 4. Carrier Controlled Personalized Electronic Vault System

This example may be administered by companies such as UPS or Federal Express.

Option 1: Delivery company (deliverer or carrier) puts vault delivery option link on vendor's website. Clicking link goes to vault page on carrier's site. Carrier administers vault service, receives barcode from vendor, transmits barcode to vault, picks up package, delivers package, receives delivery notice packet from vault, transmits delivery confirmation to vendor and to purchaser. Delivery notification may come from vendor instead of purchaser. Promotes carrier service, more secure than other carriers.

Option 2: Like option 1 except carrier allows vendor to access boxes by providing access numbers to vaults correlated to purchaser identities or addresses, in exchange for a commission. Carrier may also require that purchaser use the carrier service for delivery if the vault system is to be used for delivery.

Option 3: carrier licenses a vendor to act as the primary vendor as in 1 and 2 above. Vendor must use carrier to use vault system. Sub-vendors may go through primary vendor as in 2 above, but must use carrier.

### 5. Cellular Example

The following example is an e-box, lock-phone product for a cellular phone company such as Verizon, Cingular, AT&T, etc. The product is a hybrid of a cellular phone and a lock box for containing a key and limiting access to a key for any purpose including but not limited to an enclosure such as a house, apartment, locker, garage, car or any other type of key-operated enclosure.

In the preferred design, the box includes a chamber for containing a key; a linkage device for securing the box to a door knob, railing, chain link, fence, handle fixture, etc.; a radio transceiver for receiving and transmitting messages through a cellular network; and a controller programmed to receive entry instructions via text messaging from another cell phone. The lock-phone is designed for use, for example, by a family who resides at a residence. The lock-phone may be purchased from the cellular phone company that serves the family. Just as the family may add phones to a plan for additional family members, the family may purchase a lock-phone to provide controlled access for various purposes as outlined above. One or more phones in the family set may be designated as a master to the lock-phone. A master phone controls the lock-phone by instant messaging. The master may establish and edit a list of phone holders, identified by phone numbers, which may gain entry to the box simply by calling it. The master may also establish and edit a list of phone holders, identified by phone numbers, that may gain entry to the box only once, and possibly only at a certain time. The master may also permit entry by setting a code to be typed in after calling the lock-phone number. The master may change the entry code for the lock-phone at any time. The master may post a message on the lock-phone. The master may establish entry codes for particular vendors or service companies. The master may set time windows for various entry codes. The master may post a message that says: “call me” with a phone number. The recipient who desires entry, for example, a delivery person, calls the master, who may then decide to unlock the key chamber remotely by messaging the master's code. The possibilities are many, and the cellular networks are the best companies to offer such a product.

### MODIFICATIONS

Any of the examples 1-4 above may be combined or implemented with the examples illustrated in the figures shown and discussed above.

This application also incorporates by reference the following U.S. Pat. Nos. 3,657,720; 3,864,675; 4,319,230; 4,322,714; 4,517,660; 4,665,379; 4,680,785; 4,700,374; 4,727,368; 4,754,255; 4,760,402; 4,809,316; 4,811,026; 4,818,987; 4,870,419; 4,877,947; 4,887,064; 4,887,091; 4,893,240; 4,935,745; 4,944,422; 5,192,947; 5,335,264; 5,347,833; 5,418,537; 5,432,495; 5,490,200; 5,606,307; 5,905,446; 5,960,411; 6,014,636; and 6,021,324.

The disclosure set forth above encompasses multiple distinct inventions with independent utility. While each of these inventions has been disclosed in a preferred form or method, the specific alternatives, embodiments, and/or methods thereof as disclosed and illustrated herein are not to be considered in a limiting sense, as numerous variations are possible. The present disclosure includes all novel and non-obvious combinations and subcombinations of the various elements, features, functions, properties, methods and/or steps disclosed herein. Similarly, where any disclosure above or claim below recites “a” or “a first” element, step of a method, or the equivalent thereof, such disclosure or claim should be understood to include one or more such elements or steps, neither requiring nor excluding two or more such elements or steps.

Inventions embodied in various combinations and subcombinations of features, functions, elements, properties, steps and/or methods may be claimed through presentation of claims in a related application.

The following numbered paragraphs further describe and define the invention:

1. A system for selling and delivering goods comprising
a vendor computer system offering goods for sale on a vending website that is accessible from a purchasing computer via the world wide web, the vendor computer system being programmed to carry out a sales transaction with a purchaser of goods operating from the purchasing computer,
an electronic lock box at a fixed location near a locked door providing access to a secure enclosure, the lock box including a chamber for housing a key configured to lock and unlock the door, a receiver for receiving transaction-specific entry codes from the vendor, and an entry code input mechanism,
the vendor computer system being programmed to: (a) prompt the purchaser whether to have the goods delivered inside the enclosure via the lock box, (b) assign a transaction-specific entry code for accessing the lock box, (c) communicate the transaction-specific entry code to the lock box, and (d) provide the transaction-specific entry code to a deliverer in a form configured for input into the entry code input mechanism of the electronic lock box.

2. The system of paragraph 1, wherein the lock box is vendor specific.

3. The system of paragraph 1, wherein the vendor communicates remotely with the box to track delivery of goods.

4. The system of paragraph 1, wherein the entry code input mechanism is configured to receive a code from a device that allows a delivery person to enter a transaction-specific code to the entry code input mechanism without actually having knowledge of the code itself.

5. The system of paragraph 1, wherein the entry code input system includes a scanner for scanning a bar code.

6. The system of paragraph 1, wherein the purchasing computer is located in the enclosure.

7. The system of paragraph 1, wherein at least one video recording device is positioned around the enclosure in a location calculated to record activity of a delivery person in or around the enclosure.

8. The system of paragraph 1, wherein a sound or motion sensor and switch are configured to turn the video recording device on when a delivery person begins an entry event

9. The system of paragraph 1, wherein the e-lock is equipped with a transceiver configured to transmit a signal causing the video recording device to record when a transaction-specific entry criteria are satisfied.

10. The system of paragraph 1, wherein the e-lock is equipped with a transceiver configured to transmit data concerning an entry event to the vendor computer

11. A method of transferring goods comprising
accessing a vendor's web site through a personal computer and a modem at a premises,
selecting an item for purchase from the vendor,
assigning a transaction-specific entry code derived from the vendor for a limited purpose of permitting a one-time entry of the premises through an e-lock located at the premises,
unlocking the e-lock by entering the transaction-specific entry code, and
delivering the purchased item into the premises.

12. The method of paragraph 11 further comprising
communicating the transaction-specific entry code from the vendor to the e-lock.

13. The method of paragraph 11 further comprising
manually entering the transaction-specific entry code into the e-lock.

14. The method of paragraph 13 further comprising
communicating an instruction packet from the vendor to the e-lock, wherein the instruction packet includes the transaction specific entry code, and at least one other entry parameter selected from the following group: (a) when the entry is permitted, (b) who may enter, (c) who may not enter, (d) that a personal identifying code be entered prior to entry, (e) and a confirmation code that can be accessed remotely by a delivery person to indicate that the e-lock is ready to receive delivery of the item.

15. A lock device comprising
a latch mechanism,
a receiver configured to receive entry instructions from a remote server operated by a vendor that is programmed to transmit entry criteria relating to a specific agreement to exchange goods,
a processor programmed to receive entry instructions from the receiver and to permit unlocking of the latch mechanism when the entry criteria are satisfied.

16. The lock device of claim 15 further comprising
a transmitter configured to communicate information concerning an unlock event to the lock server.

17. The lock device of claim 15 further comprising
a clock device linked to the processor so that the processor can determine whether a time-specific entry criterium has been satisfied.

18. The lock device of claim 15 further comprising
a data input device that allows a person to input an entry code into the lock device.
